(19) United States
(12) Patent Application Publication
(10) Pub. No.: US 2003/0154289 A1
(43) Pub. Date: Aug. 14, 2003

(54) Methods of interacting with distributed information networks

(76) Inventors: Matthew Murray Williamson, Bristol (GB); Peter James Rodgers, Wotton-Under-Edge (GB)

Correspondence Address: HEWLETT-PACKARD COMPANY, Intellectual Property Administration, P.O. Box 272400, Fort Collins, CO, 80527-2400, US

(21) Appl. No.: 10/351,023

(22) Filed: Jan. 24, 2003

(30) Foreign Application Priority Data
Jan. 25, 2002 (GB) 0201692.1

(51) Int. Cl. G06F 15/16

(52) U.S. Cl. 709/227

(57) ABSTRACT

A method of enabling reuse of Web session data generated at a server in a client/server environment is described. The method comprises: recording a user's interaction with a Web site thereby producing Web session data; converting the Web session data into a document having a portable format; and transferring the portable format document to a user such that it may be reused to regenerate at least a part of the Web session at a later point in time. The portable document, typically in an XML format with XSL formatting instructions, can be passed to different users for editing and use by them and makes the Web session data browser and server independent.

### TECHNICAL FIELD

The present invention concerns improvements relating to methods of interacting with distributed information networks. More particularly, though not exclusively, the present invention relates to an improved way of interacting with different Web sites via the Internet, which enables users to share other users' browsing experiences and to discontinuously browse the Internet without requiring mass data entry. The present invention has application in many Internet usage areas including Internet shopping.

### BACKGROUND ART

The Internet is a collection of computers and computer networks that use the TCP/IP suite of protocols to communicate with one another via communication links. The Internet offers a range of different services to users, services such as email, FTP, Gopher, Telnet, and the World Wide Web. The World Wide Web (referred to hereinafter as the “Web”) is a set of interlinked documents that reside on server computers that are located all over the world. These interlinked documents are known as “Web pages”, and are typically written in Hypertext Markup Language (HTML). Web pages are identified by Uniform Resource Locators (URLs) which specify the particular host and pathname by which the Web page can be accessed.

A group of related Web pages and other elements such as files, scripts, databases and images may be combined to form a Web site. The Web pages that belong to the Web site generally cover one or more related topics and are interconnected by hyperlinks. Hyperlinks are connections between an element such as an image, word or phrase in a Web page and a different element in the same document, or between any of the aforesaid elements and another document. A hyperlink is activated by the user by clicking on the link which is generally underlined or in a different colour from the rest of the document text. The majority of Web sites have as their starting point a home page, which usually functions as a table of contents for the site.

In order to view a Web site, the Web pages are transmitted from a server computer to a user computer (known as a “client computer”) using the HTTP protocol, and are displayed in a Web browser. A Web browser is a software application that lets a user locate and view HTML documents. In order to access a Web page, the user enters the URL of the Web page in the Web browser, and the Web browser locates and displays the requested Web page.

The HTTP protocol is stateless. This means that each time a Web browser requests a Web page from a server, the request is treated as a completely new interaction. The fact that the request may be just the most recent in a series of requests as a user browses through the Web site is lost. Although this makes the Web more efficient, this stateless behaviour makes it difficult to create things like shopping carts that have to remember the user's actions over an extended period of time. “Cookies” were developed by the Netscape Corporation in order to solve this problem, i.e. they provide a way of conducting state management over stateless protocols such as HTTP.

A cookie is a small file that a Web server places on a user's computer. The user's Web browser can be programmed such that the contents of the cookie file are submitted to the server along with every request made to the server. By inserting information in the cookie, the Web server can distinguish between related and unrelated requests, and related requests can be organised into sessions. For example, when a user visits for the first time a Web site that uses cookies, the Web site will place a cookie on the user's computer. The cookie contains some identifier which allows the server to track the interaction of the user with the Web site. If the user enters some form of customising information that is stored at the server, the identifier in the cookie can be used by the server to locate that information stored on the server and, for example, present customised Web pages to the user.

Cookies can also be utilised to allow use of different Web browsers to access a Web site. This is achieved by “logins” whereby a user enters their personal details once and is assigned a username and password. These personal details are stored on the server, and the user can login to the Web site via any Web browser by using their username/password. This is implemented in the following manner. When the user logs onto a Web site for the first time, the site sends a cookie to the user's Web browser which allows the user's interaction with the Web site to be saved as a session. When a user subsequently logs into the same Web site using a different browser, the username/password identifies and authenticates the user, and a new cookie identifier is then created to point to the user's details which are stored at the Web site. A disadvantage of this method is that the username/password combination is bound to a particular user: there is no way for a different user to see the state seen by a first user without sharing the first user's username and password.

As stated previously, cookies enable the state of a user's interaction with a Web site to be managed over the stateless HTTP protocol. However, this state (or session) information stored on the server is not available for use by the user: a cookie only provides a means for linking the user to this information. The actual details of the user's interaction with a Web site cannot be passed to a user using cookies, and therefore this data (referred to hereinafter as “Web session data”) cannot be controlled by the user.

Accordingly, it is desired to provide a method of storing and re-using state (or session) information that relates to a user's interaction with a Web site which overcomes or substantially reduces the above mentioned problems.

### DISCLOSURE OF INVENTION

According to one aspect of the present invention there is provided a method of enabling reuse of Web session data generated at a server computer in a client/server environment during a Web session, the method comprising: recording a client's interaction with a Web site thereby producing Web session data describing the Web session; converting the Web session data into a document having a portable format; and transferring the portable format document to a user such that it may be reused to regenerate at least a part of the Web session at a later point in time.

A Web session is defined as the actions a user takes while interacting with at least one Web page of the Web site. The user may interact with a Web site by entering the URL of a Web page into a Web browser, or by clicking on hyperlinks displayed in a Web page. Alternatively, the user may interact with a Web site by filling in a form that is displayed in the Web browser, adding items to a shopping cart, or by checking check boxes, or radio buttons etc.

Each time a user clicks on a hyperlink or a button displayed in a Web page, or submits a filled in form to the server etc, this information may be logged at the server. In an embodiment of the present invention, the server is configured to log and store this information (or data) at the server. The logged and stored (i.e., captured) information is referred to hereinafter as “Web session data”.

The captured Web session data may alternatively be saved on another server that is in communication with the server, or in a further alternative it may be stored on a database in communication with the server, i.e. on the “server side” of the client/server environment.

The portable format is a data structure that is transferable from the server-side of the client-server environment to the client-side. The portable format may be understood by only one particular server and at least one client, or by one particular server and a plurality of clients, or by a plurality of servers and a plurality of clients. Most preferably the portable format is easily read and understood by one or more users, and can advantageously be in a non-proprietary, non-implementation specific format.

The advantage of using a portable format to store Web session data is that it enables both the server and the user to read the data, and it also makes the data readable on different computers by different Web browsers. This format also enables a navigational history to be taken that is user independent rather than computer or application specific. The present invention can thus be considered to be a way of obtaining and storing a universally usable history of the actions a user took while visiting (or interacting with) a Web site, and enabling the user to recreate their visit at a later date without having to re-key in all of the navigation commands or option selections made previously. Another advantage of using a portable format is that usually different Web sites store Web session data in different formats. This means that a user is unable to save session data from one Web site and re-use it at another Web site. The invention therefore enables re-use of Web session data by different servers.

For example, Web session data may be converted into a markup document that is written in eXtensible Markup Language (XML) so that any client can read the document and any server can render the document. Alternatively, the session data may be converted into a markup document that is written in HTML, or most preferably the session data is embedded and displayed in an HTML form. It will, however, be appreciated by the skilled person that the method of the invention is independent of the type of portable format used: any suitable markup language or data structure may be utilised. For instance, the session data could be embedded in a Web session document using hidden form fields.

XML is a relatively new markup language that is designed to make information “self-describing”. XML consists of rules that can be used to create a user-defined markup language. One rule is that tags must always be used in pairs and must surround the data that the tag, refers to. Another rule is that tags can be nested inside one another so as to form a tree. XML, can thus not only be processed and understood by a computer program, but advantageously it can also be understood by a user as it is written in ordinary text.

The Web session document containing Web session data (or some portion thereof) can be sent from the server-side of the client-server environment back to the user so that some or all of the Web session may be recreated at a later date. This document may be sent via HTTP, email, FTP, or any other suitable method. Preferably the user requests that the session data document be sent to him. This may be achieved by having a button displayed on a Web page of the Web site so that by clicking on the button, the Web session document is sent to the client computer. Alternatively, the server may offer the user the option of retrieving the Web session document. The Web session document may be sent to the user at any point during the Web session.

The portable format of the Web session document preferably enables the session data therein to be edited by one or more users. The Web session data document may be passed around from user to user by email, for example, so that any number of users can edit the document. However, it is also possible that no amendments to the document are required so that the session data within the Web session document remains unchanged. Most preferably, a first user interacts with a Web site using a first Web browser and requests session data be sent to him. He then sends the Web session document to a second user who then regenerates the session using a second Web browser. The advantages of this are that the strong/dedicated link between the Web browser and the Web site at the client-side of the client-server environment is broken, and that the state may now be managed on the client-side, rather than on the server-side as occurs in the prior art.

It is advantageous (although not essential) that the second user reconnects to the Web site and sends the Web session document back to the server to regenerate the whole or part of the first user's interaction with the Web site. The Web session document may be sent back to the server in a number of different ways.

Firstly, if the Web session data is embedded in an HTML form contained within an HTML Web page, the HTML Web page may be loaded locally (i.e., from the client computer) into the second user's Web browser (e.g., by entering the URL “file://C:/temp/session.html”) in order to display the Web session data off-line. The second user may then go on-line and post the HTML form containing the Web session data back to the server in order that the Web session may be regenerated.

Secondly, if the server offers an “upload” facility, a local HTML page (or a local document in any other suitable portable format) containing session data may be uploaded to the server. For example, the second user may connect to an “upload” Web page of the Web site. The Web page displayed may permit the second user to select the file to be uploaded to the server, or allow the second user to enter the filename of the Web session document. In this way, the Web session data does not have to be redisplayed in the Web browser—it is sent directly to the server.

As explained briefly in the introduction, Web pages are mostly written in HTML. HTML uses predefined tags such as <p>(which denotes the start of a paragraph) and <b>(which denotes bold text) in order to format the information in a Web page. The meaning of these tags is well understood by the Web browser. With XML, any tags at all can be used as their meaning is user-defined. However, the meaning of these tags will not automatically be understood by the Web browser. For example, <table>could mean an HTML table, or if used in a document written in XML it could mean a piece of furniture.

As there is no standard way of displaying an XML document, a method is required of describing how the document should be displayed. One method of instructing how an XML document is to be displayed is through the use of “style sheets” such as eXtensible Stylesheet Language (XSL) or eXensible Stylesheet Language with Transformations (XSLT), both of which will be referred to hereinafter as XSL. This is achieved by the XML document containing a reference to the name (and possibly the location) of its corresponding XSL stylesheet. XSL can transform XML into HTML or XHTML, and can also format the data in the XML document based on the value of the data. XSL files are themselves written in XML.

A third method of sending the Web session document back to the server is by creating, for example, a local HTML page by taking an XML Web session document together with a. transformation defined in the XSL stylesheet, and running the transformation on the client-side of the client server environment. The XML Web session document may be transformed using dedicated software located on the client machine, or even by a Web browser such as Microsoft's Internet Explorer version 6.0. The local page generated in this manner would display the session data which could then be sent from the client to the server by either uploading the page itself, or by posting a form displayed in the page. The form may be an HTML form that displays the session data, or an XForm. Alternatively, the local page generated by the XML and transformation may be saved locally and uploaded to the server at a later date. The XSL stylesheet is preferably sent to the client machine along with the XML document where it is stored as a local file. However, it may be retained on the server-side of the client-server environment.

Another method of sending the session data back to the server is by the use of applets. An applet is a small Java program that can be downloaded over the Internet and executed on the recipient's machine. The applet may be used to retrieve the Web session document from the client machine. For example, a user connects to a “reload session data” Web page. The server sends the applet to the client machine. The applet finds the correct Web session document on the client machine. The user presses, for example, a “go” or “send data” button displayed on the Web page and the Web browser sends the Web session document back to the server. The Web session document therefore does not have to be displayed on the Web browser. An ActiveX control may be used in a similar manner to locate Web session documents on the client machine.

Preferably the applets used are “signed” applets. Signed applets have the security privileges needed to access, for example, the file system on a client-side computer, or to open a new connection to a server.

The Web session data may be in the form of navigational data i.e., the Web session document may record the Web pages that have been “visited” by a user. In this case, by “interacting with the Web site” it is meant that the user is navigating a Web site. As an example, the invention may be used to replay navigation of an estate agent's Web site. While visiting the estate agent's Web site, the user may interact with a database that is in communication with the server in order to search for properties. Once a property of interest has been identified, the user may then take a virtual tour of the property by navigating the rooms of the property. Each room of the property may thus comprise a separate Web page. Session data (i.e., navigational data) is then preferably logged and captured at the server-side, and is subsequently converted into a Web session document and returned to the client-side. The Web session document in this instance is preferably an HTML Web page, although it may be in the form of an XML document. The user, at the client side, then has the option of replaying the navigation history by regenerating the session at a later date, or of forwarding the document to another user for the same purpose.

Most preferably, a first user interacts with the Web site via a first Web browser, obtains the Web session document which contains navigational data, and then forwards this document to a second user. If the Web session document is an XML document, the second user can transform the XML document into an HTML page, and subsequently load the HTML page off-line into his Web browser. Alternatively, the XML document may be transformed into a file/document that is suitable for display on a Web browser by the Web browser itself. The HTML page (or any other suitable file) preferably contains hyperlinks to pages of the navigation undertaken by the first user. The second user may look at pages of the navigation by clicking on the hyperlinks and thereby establishing an on-line connection to the server. In this case, the navigational session data does not have to be replayed in the same order as it was captured by the server.

The sharing of a Web session experience without requiring rekeying of data is now made possible by the present invention. A user is also now advantageously able to have a discontinuous interaction with a Web site of sites without rekeying of navigation and interaction data, such that Web sessions can be saved, edited, and passed to others for use.

It will be appreciated by those skilled in the art that the editing of Web session data may be performed at the server-side (for example, at an “up-load site”), or the client-side (using, for example, a specific or generic editing tool).

With navigational Web session data, it is not a requirement that the Web session data is sent back to the server—the Web session may be regenerated locally from the client-side. However, in order that the navigation can be played back automatically without any user intervention (i.e., in the form of a movie or slide show), the second or subsequent user may send the Web session document back to the server. The user in this instance may be given the opportunity to choose the speed of replay of the navigation. For example, each frame or slide of the navigational history may be to replayed every second, every five seconds, or every minute, etc.

Even though the present invention has been described in relation to the re-use of Web session data, it will be apparent to a skilled person that the pages do not have to reside on the World Wide Web. They might be located on another type of network such as an intranet, or even on a local hard drive.

A Web site may be part of a larger group of Web sites that are all configured to accept the same session data document for re-use. These Web sites may reside on different servers and different domains. This group of Web sites may form a virtual shopping centre or department store. If the method of the invention is to be used with such a group of Web sites, then a user may connect to any of the group of Web sites, interact with these Web sites by adding goods to a shopping cart, and then make a request for the session data. The session data document may show the name of the Web site at which the user wishes to make a purchase, the goods that the user wishes to purchase, the cost of the goods, etc. The session data may then be sent to a payment of check-out server and a single credit card transaction carried out to finalise the purchase. The advantage of this is that the user does not have to re-enter personal details such as their address or credit card details each time they shop at a different Web site. Another advantage is that the purchaser only pays for goods bought from different Web sites once via a single transaction, rather than via single transactions on each Web site. A further advantage is that companies can share billing infrastructure expense.

A further advantage of the invention is that not only can the Web session data be read by a computer, but the information stored in the document can be reused by different Web sites due to the general nature of the portable language. This means that a user is able to save session data from one Web site and re-use it at another Web site.

According to another aspect of the present invention there is provided a system for enabling reuse of Web session data generated at a server in a client/server environment during a Web session, the system comprising: communication means for supporting communications between a user and a Web site; capture means arranged to capture session data arising from the user's interaction with the Web site; conversion means arranged to convert the session data into a document having a portable format; and transfer means for transferring the portable document to the user from the server computer via the communications means.

Preferably the communications means comprises a wide area communications network and the system further comprises a client computer arranged to communicate over the communications network.

The client computer preferably has a Web browser to which Web pages of a Web site can be sent by the server.

The capture means preferably includes a Java servlet or other such program that sits on the server side of the client/server system. A servlet may also be used as the conversion means for converting session data which may be stored on the server into a session data document. The servlet may also be used as part of the transfer means when transferring session data documents from the server side to the client. When transferring the session data document from the client to the server side, a Web browser is the software application of choice. The Web browser may contain a Java applet for identifying the location of the session data document on the client machine.

The present invention may also be extended to a data carrier comprising a computer program arranged to configure a client/server system to implement the method of the present invention.

### BRIEF DESCRIPTION OF DRAWINGS

A number of embodiments of the invention will now be described, by way of example only, with reference to the accompanying Figures, in which:

FIG. 1 is a diagram of a client-server system suitable for implementing both the first and second embodiments of the present invention;

FIG. 2a is a flow diagram showing the steps of the first part of the first embodiment of the present invention wherein Web session data is stored at the server and sent to a user;

FIG. 2b is a flow diagram showing the steps of the first part of the second embodiment of the present invention wherein Web session data is stored at the server and sent to a user;

FIG. 3a is a flow diagram showing the steps of the second part of the first embodiment of the present invention wherein Web session data is sent to the server and subsequently reused;

FIG. 3b is a flow diagram showing the steps of the second part of the second embodiment of the present invention wherein Web session data is sent to the server and subsequently reused.

FIG. 4 is a flow diagram showing the how the steps of the first part of the first embodiment of the present invention are used to purchase goods on the Internet;

FIG. 5 is a simplified representation of a Web page generated during the steps of FIG. 4 when a user purchases goods on the Internet;

FIG. 6 is an XML document generated during implementation of the steps of FIG. 5;

FIG. 7 is an edited version of the XML document of FIG. 6;

FIG. 8 is a flow diagram showing the use of the second part of the second embodiment of the present invention to purchase goods on the Internet;

FIG. 9 is a simplified representation of a Web page generated in the final step of the second part of the second embodiment of the present invention shown in FIG. 8;

FIG. 10 is a flow diagram showing how the steps of the first part of the second embodiment of the present invention are used to navigate a Web site;

FIG. 11 is an XML document generated during implementation of the steps of FIG. 10;

FIG. 12 is a flow diagram showing the steps of the second part of the second embodiment of the present invention to replay the navigation generated using the steps shown in FIG. 10;

FIG. 13 is a simplified representation of a Web page generated during the steps of FIG. 12; and

FIG. 14 is a screen-shot of a Web page displaying editable XML code.

### DETAILED DESCRIPTION OF PREFERRED EMBODIMENTS

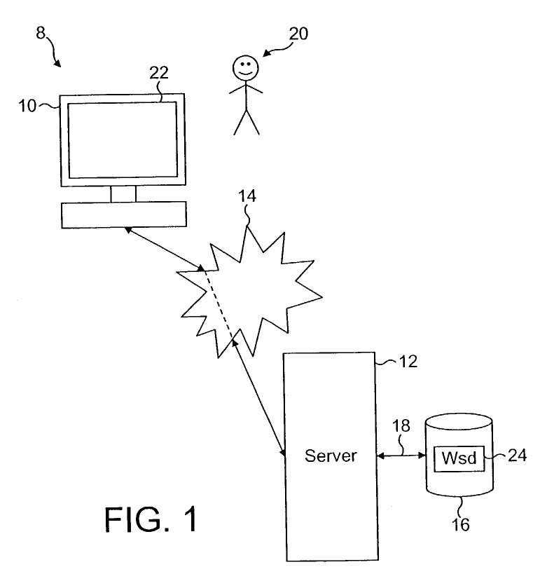

Referring firstly to FIG. 1 there is shown a client-server system 8 known in the prior art which is suitable for implementing both the first and second embodiments of the invention. The client-server system 8 comprises a client computer 10 which is connected to a server computer 12 via the Internet 14. The server 12 is optionally connected to a database 16 by way of a further connection 18. The arrows in the Figure indicate that data can be exchanged in both directions between the client computer 10 and the server 12, and between the server 12 and the database 16. In order to enable a user 20 to navigate through the Internet to different servers and Web sites, the client computer 10 has an Internet or Web browser 22 provided. At the server side of the system 8, a file of Web session data 24 (described in detail later) is provided in the database 16. The first and second embodiments of the present invention will now be described.

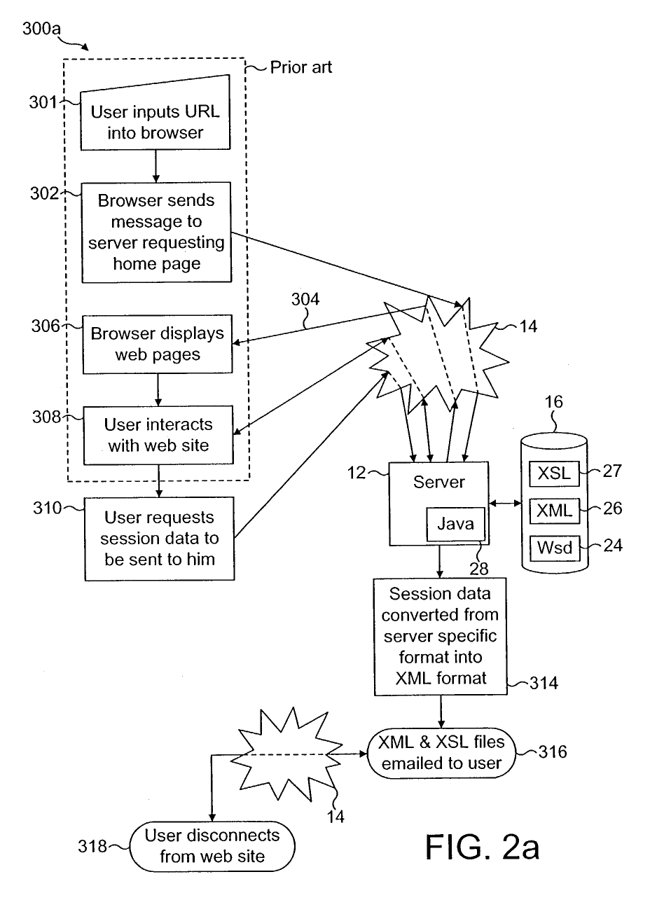

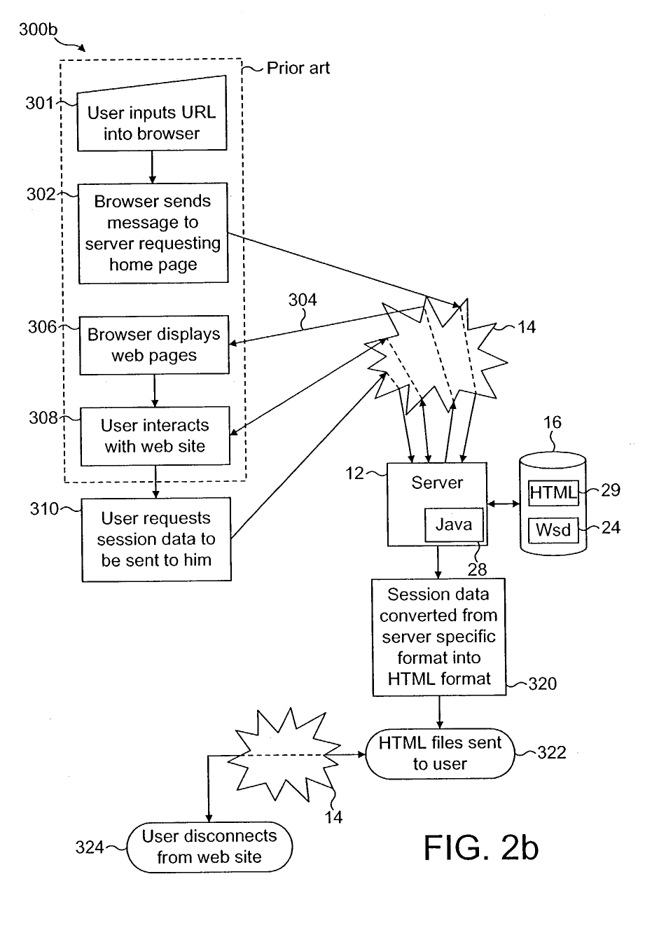

With reference to FIG. 2a, there is shown an overview of a first part of a method according to a first embodiment of the present invention. The first part 300a of the method commences with a first user 20a entering at step 301 the URL of the home page of a Web site into a first Web browser 22a. The Web browser sends at step 302 a message (in the form of a “GET” request) to the server 12 requesting the home page. The server 12 processes this request and retrieves the requested Web page. The Web page may be stored on the server 12, or on the database 16 which may be local to, or remote from, the server. Alternatively, the Web pages may reside on a remote server (not shown), or be generated dynamically at the server 12.

The requested Web page is then transferred at step 304 to the client computer 10 via the Internet 14 and the Web page is displayed at step 306 by the Web browser 22a. The first user 20a is then able to look at the requested Web page.

At the next stage of the method, the first user 20a interacts at step 308 with the Web site via the Web browser 22a. By interaction, it is meant that the user may look at different pages of the Web site by, for example, clicking on a hyperlink (not shown) displayed in the Web page thereby enabling the user to jump from one page to another and thus navigate the whole Web site, or the user may take steps to purchase goods or request information from the Web site, and so on. The user may purchase goods or request information from a Web site by filling out forms, or by checking check boxes or radio buttons etc.

Each time the first user 20a clicks on a hyperlink or a button displayed in a Web page, or submits a form to the server etc, a message is sent from the Web browser 22a to the server 12. If the user clicks on a hyperlink to request a new Web page, this message will be in the form of a GET request, whereas, if the user is submitting a form to the server, this message will most likely be in the form of a POST request. The information resulting from such requests can be logged by the Web server 12. The aforementioned steps 301 to 308, and the step of logging certain aspects of a Web session at the server are known in the prior art.

The next step of the method involves the logged data being processed by a Java servlet 28 provided on the server, and subsequently being stored as Web session data 24 in the database 16. When the user 20 has finished either visiting or navigating the Web site, or has taken steps towards the purchasing of goods from the Web site, he requests at 310 that the session data which resides on the server be sent to him.

The Java servlet 28 processes the user's request and converts at step 314 the Web session data 24 stored on the database 16 into an XML document 26. The first and/or second user is therefore able to read and/or edit the session data 24 contained therein. Alternatively, the original unedited XML session data may be re-used. In order that the XML document 26 may be formatted, an accompanying XSL file 27 is also sent to the user 20a. The XML document 26 and the XSL file 27 are then sent at step 316 to the first user 20a via electronic mail. The user then disconnects at step 318 from the Web site, although this step is optional. The Web session data 24 is therefore stored at the client 10 rather than at the server 12, thus breaking the strong link between the Web browser and the Web site at the client side of the client-server environment.

As details of the Web session are now kept at the client 10 (rather than the server 12), this allows the Web session to be edited, passed from one user to another, allows the Web session to be regenerated, or even permits the data from the Web session to be sent to other servers thereby breaking the strong link between the Web browser and the server.

Referring now to FIG. 2b, there is shown an overview of a first part of a method according to the second embodiment of the present invention which is a similar but alternative method to that described in the first embodiment. The first part of the method 300b comprises a first user 20a interacting with a Web site. Steps 301 to 308 of this embodiment of the invention are identical to method steps 301 to 308 of the first embodiment of the invention, and will therefore not be discussed further.

After the first user 20a has interacted with a Web site in the manner described above, he requests at step 310 that the Web session data be sent to him. The Web session data is converted at step 320 into an HTML file 29 at the server 12 by the Java servlet 28. This HTML file 29 is sent at step 322 to the first user using, for example, the HTTP protocol.

Upon receiving the HTML file 29, the user 20a may then disconnect at step 324 from the Web site.

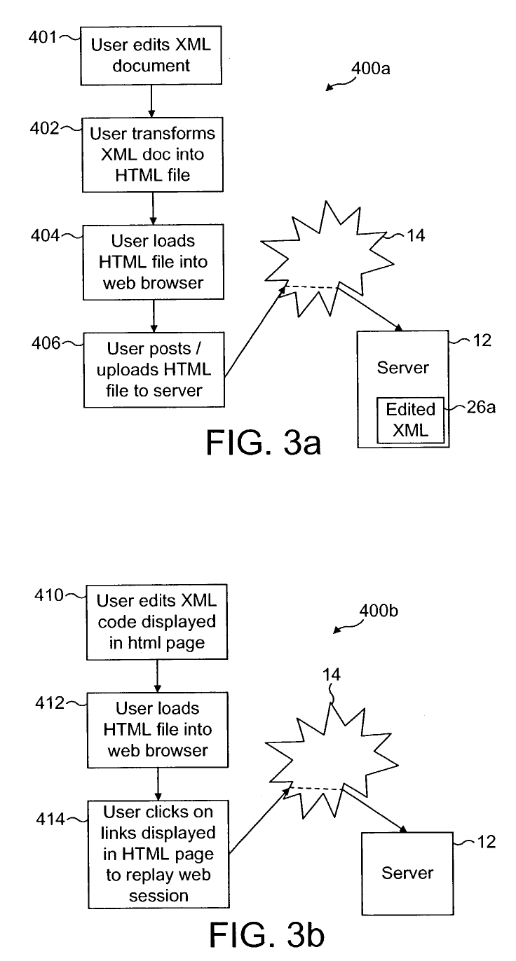

A second part 400a of the method according to the first embodiment of the invention where the session data 24 is reused by a second user 20b is now described with reference to FIG. 3a.

The second part 400a commences with either the first and/or a second user 20b (to whom the Web session data has been passed) editing at step 401 the XML document to form an edited XML document 26a (this step is optional). When the second user 20b wishes to reuse the Web session data, he transforms the edited XML document 26a into an HTML file using dedicated software, or he loads the XML document into a suitable Web browser for transformation. Taking the case where the second user 20b does not have a Web browser that transforms XML files directly, the second user transforms at step 402 the edited XML document 26a into an HTML file using the XSL file 27. This transformation step is carried out at the client-side 10 so that the HTML file created is local to the second user 20b. The second user 20b loads at step 404 the local HTML file into his Web browser 22b thereby displaying the edited Web session as a Web page. The HTML file containing the amended Web session data is then sent at step 406 to the server 12. To facilitate the sending of this information to the server, and to give the second user 20b a final opportunity to edit the Web session data, the Web session data can be displayed as an HTML form in the Web page. The HTML form can be posted to the server 12 by clicking on a button displayed in the Web page.

If the user 20b does not wish to display the Web session again, but simply wishes to send the Web session data to the server, then step 404 does not have to be carried out. In this scenario, the user 20b logs onto a Web site that will accept the HTML file. The second user then goes to, for example, an “upload Web session data” page of the Web site. This Web page might contain an “upload data” button, and will almost certainly provide the second user with a method of entering the name and path of the local HTML file, such as a browse facility or a text box (although applets and ActiveX controls can be used to automatically locate the local HTML file on the user's machine). To send the Web session data to the server 12, all the second user has to do is click on the “upload data” button.

Although only two examples of sending the Web session data back to the server 12 have been described, a skilled person will appreciate that there are many other suitable methods which can be used.

The second part of the method 400b according to the second embodiment of the invention where the session data 24 is reused by a second user 20b (to whom the Web session data 24 has been passed) is now described with reference to FIG. 3b. This embodiment of the invention is more suitable than the first embodiment if the Web session document 26 comprises a single page, and/or if it is not essential to sent the Web session data back to the server 12. The session data in the second embodiment is in the form of an HTML page. The HTML page can contain an embedded form 21 containing XML code, as shown in FIG. 14. This allows the first and/or second user to edit the Web session data, if required.

The second part 400b commences with the first and/or second user editing at step 410 the XML code displayed in the HTML page. The second user then loads at step 412 the HTML page directly into his Web browser 22b thereby displaying details of the Web session generated by the first user 20a. The HTML page contains links or pointers to particular elements of the Web session, thereby enabling the second user 20b to regenerate the Web session elements of his choice by clicking at step 414 on these links.

In order to more fully explain how the method of the invention is used in practice, two examples will now be given. The first example relates to the use of the first embodiment of the invention in relation to purchasing goods over the Internet, and the second example relates to the use of the second embodiment of invention in storing and re-using navigation data.

### EXAMPLE 1

### A Virtual Shopping Centre

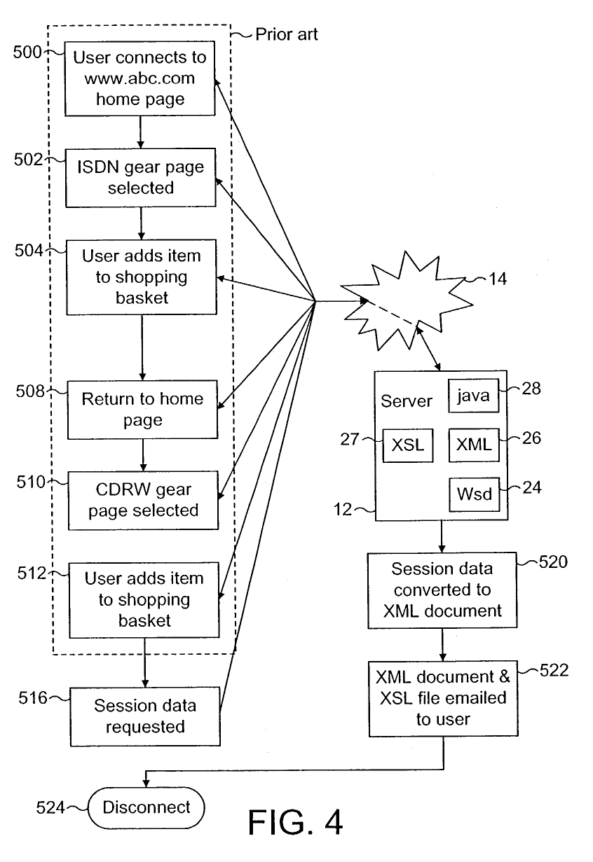

Firstly, the purchasing of goods from a single Web site using the above described method embodying the present invention is now detailed with reference to FIGS. 4 to 9.

Referring to FIG. 4, there is shown a block diagram illustrating the steps of the first part of the first embodiment of the invention when used to purchase goods over the Internet, steps 500 to 512 inclusive being known from the prior art. In this example, the first user 20a connects at step 500 to the home page of ABC Computer Goods Inc.'s Web site (“www.abc.com/home.htm”). The user then displays at step 502 the ISDN gear Web page of the Web site, and adds at step 504 a PCI 128K ISDN to the shopping basket.

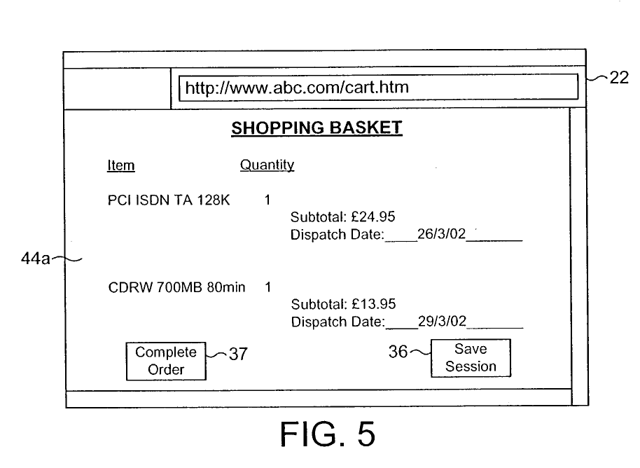

As the user 20a wishes to purchase more goods, he returns at 508 to the home page. This time, the user selects at step 510 the readable and writable compact disc (CDRW) gear Web page of the Web site. He then adds at step 512 an item to the shopping basket. When the user 20a has finished his shopping, he goes to the shopping basket Web page 44a where the details of the items he has selected are displayed. The Web page 44a is shown in FIG. 5. From this figure it can be seen that there is a button 36 labelled “save session”. The user 20a presses at step 516 this button in order to save the session data 24 at the server 12, and to request a copy of the session data 26 to be transferred to him. At the server 12, the session data (i.e., the details of his intended purchase) from this session is converted at step 520 into an XML document 26, and this is then emailed at step 522 to the first user along with the appropriate XSL file 27. The user may now disconnect at step 524 from the Internet.

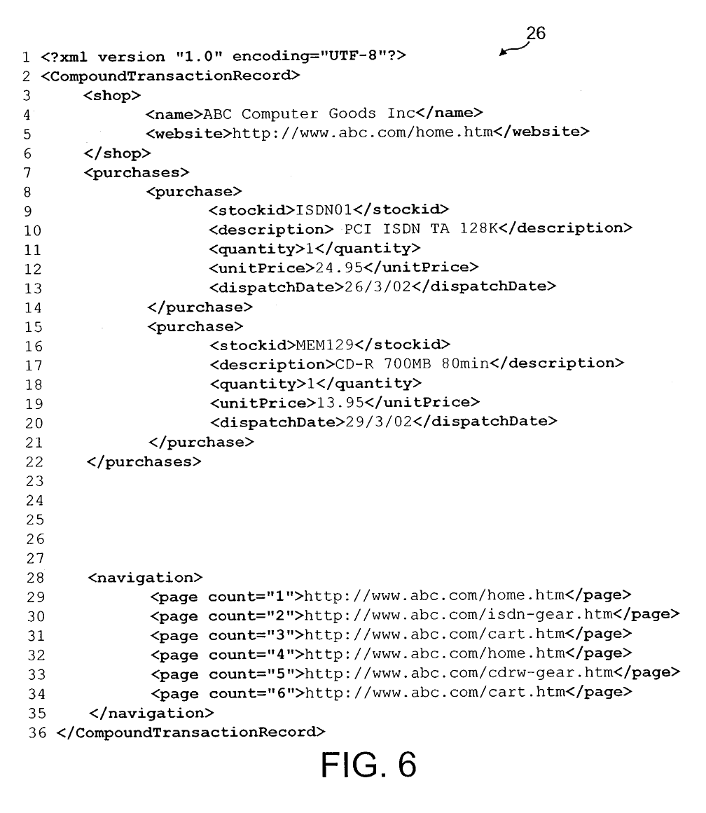

Referring now to FIG. 6, there is shown the XML Web session document 26 produced by the server 12 in response to the first user's request. As the tags in XML are user defined, the contents of the document 26 may be easily understood. For example, it can be seen from line 5 of the XML document that the user 20a has been connected to the Web site “www.abc.com” which belongs to the computer company ABC Computer Goods Inc. In line 7 of the XML document 26, the information contained within the <purchases>tags relates to the items that the user 20a wishes to purchase. It can be seen that the information surrounded by the first <purchase>tags (lines 8 to 14) relates to the ISDN gear, and the information surrounded by the second <purchase>tags (lines 15 to 21) relates to the compact discs. The navigation steps that the first user took when carrying out the purchase are illustrated by lines 29 to 34 of the XML document 26.

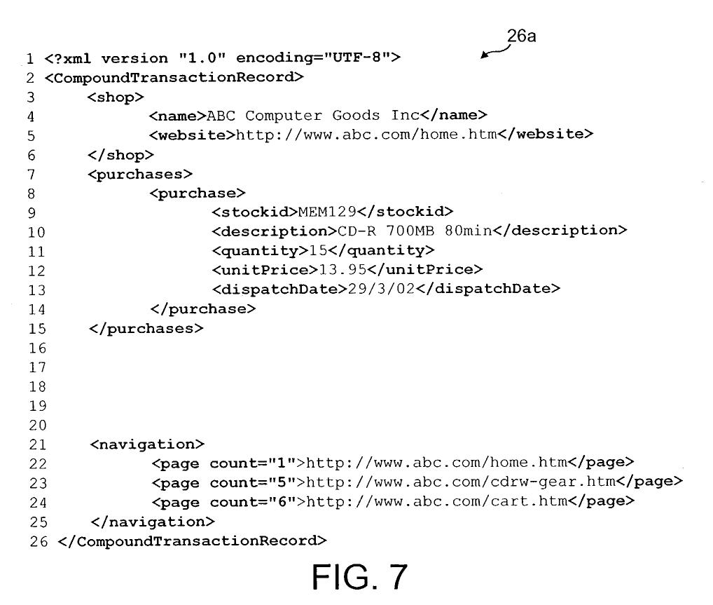

After the first user 20a has received the XML Web session document 26, he sends the document to the purchasing department so that they can approve, edit (if they wish) and complete the transaction. For example, when filling out the purchase details on-line, the user 20a wished to purchase one compact disc. However, the user's manager informs the purchasing department that the company now requires fifteen of these items, and that the order for the ISDN gear should be cancelled. A member of the purchasing department (referred to hereinafter as the second user 20b) edits the XML document 26 to reflect this information, and thereby produces the edited Web session data document 26a shown in FIG. 7.

It is apparent from comparing the edited XML document 26a in FIG. 7 with the unedited XML document 26 shown in FIG. 6, that it is a simple task to change the details of the purchase in this manner. The task can be carried out using a conventional text editor. Users may be provided with instructions about how the XML document should be edited along with the document itself. For example, in the XML document 26 shown in FIG. 6, the ISDN gear purchase details (previous lines 8 to 14) have been deleted along with the navigation information (previous lines 30 and 31) that accompanied the purchase. However, an alternative way of doing this is to change the <quantity>information for this item from one to zero, and to have the navigation information unedited. This can be indicated to users by adding comments such as “do not edit this information” next to the relevant information in the XML document 26 itself. This may be done at the time that the XML document 26 is generated by the server 12.

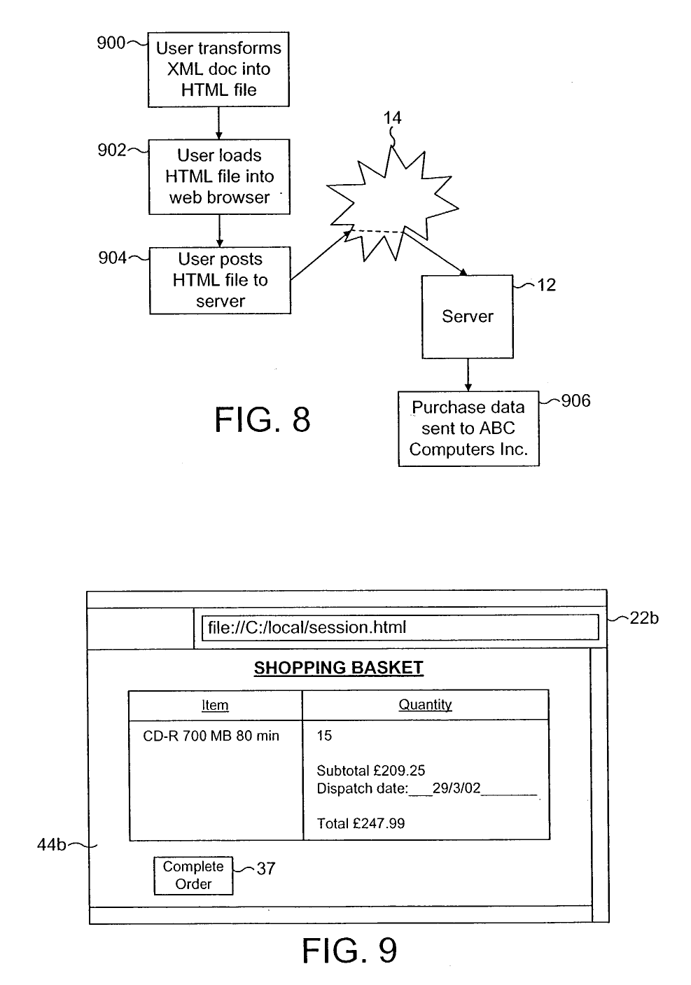

FIG. 8 illustrates how the edited XML document 26a may be used to complete the order process. The second user 20b firstly transforms at step 900 the edited XML document 26a into an HTML file using the associated XSL style sheet 27 which was emailed to the first user with the XML document 26a. This HTML file is stored locally on the second user's computer. Next, the second user loads at step 902 the HTML file into her Web browser 22b, giving the Web page 44b shown in FIG. 9. This Web page 44b shows details of the edited Web session data as an HTML form. It can also be seen from this figure that there is a “complete order” button 37 displayed on the Web page 44b. To complete the transaction, the second user 20b clicks on this button and the form data is posted at step 904 to the server 12. Finally, the form data (i.e., the order information) is communicated at step 906 to ABC Computer's Inc. This method enables a Web transaction to be carried out using two separate Web browsers 22a and 22b, which is not possible using the cookie method of the prior art.

### EXAMPLE 2

### A Virtual Estate Agent

A second example is now given which utilises the previously described second embodiment of the invention. This example relates to the storing and re-using of Web session data 24 resulting from navigating an estate agent's Web site.

As visiting estate agents and viewing properties is very time consuming, most estate agents now have a presence on the Internet providing on-line services such as search facilities (for looking for houses that meet the prospective buyer's requirements), and sometimes even virtual houses (so that prospective buyers can look around the inside and outside of a house without even having to step outside their front door).

Navigation of some Web sites can be extremely difficult and tedious, especially if the site contains a large amount of information which is spread over many Web pages. Other than bookmarking Web pages of interest, or keeping a written record of these Web pages, it can be difficult to reproduce a visit to a Web site. This, of course, is an important problem for the virtual estate agent. The user 20a of the Web site may be looking at a large number of houses, and taking virtual tours around many of these. If the user 20a wants to repeat any of these tours, or show someone else houses of interest, he has to either repeat the navigation process, or just tell the other person the URL of the Web site and hope that they somehow manage to find the information.

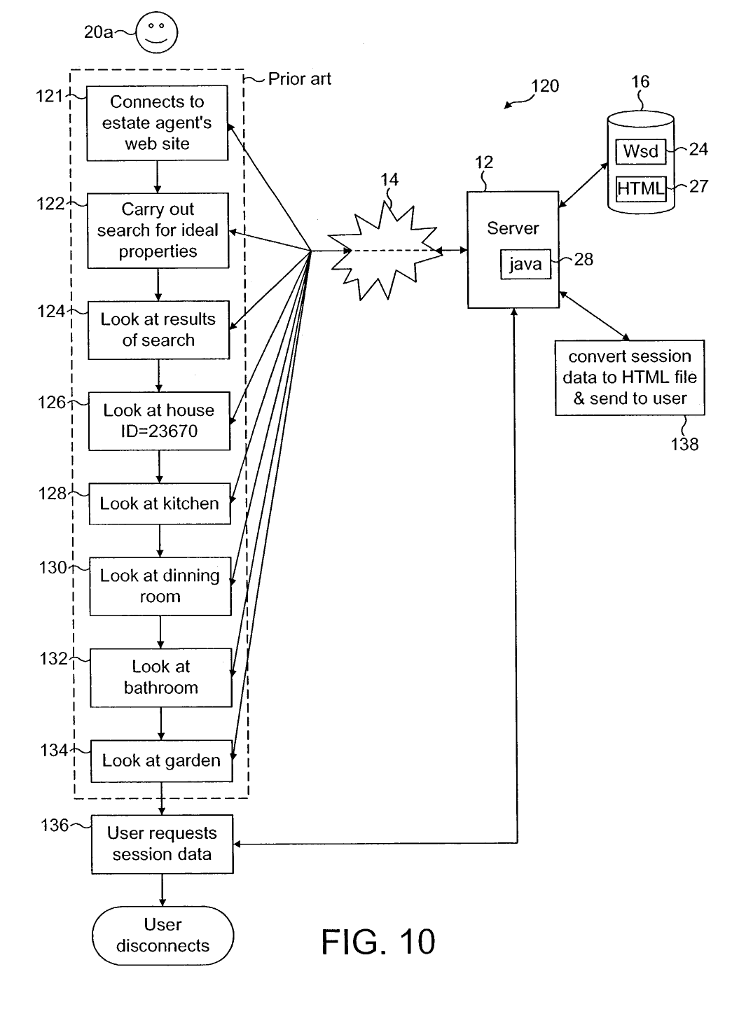

In this example, the session data 24 produced as a result of navigating through an estate agent's Web site and taking a virtual tour of a property is at first sent to a first user 20a. The process implemented in order to achieve this is shown in FIG. 10 and will now be explained.

The process 120 commences with a first user 20a connecting at step 121 to “www.lookforahome.com” (a fictitious estate agent's Web site) using a first Web browser 22a. The next stage of the process 120 involves the first user 20a carrying out at step 122 an on-line search of the estate agent's database in order to identify properties which are of interest to him. In this case, the first user 20a enters a maximum price of £180,000, a minimum price of £100,000, and the location of West London. A number of relevant properties are identified, the details of which are sent back to the first user's Web browser 22a by the server 12.

The first user 20a considers at step 124 the results of the search, and he clicks at step 126 on the image of a house with ID number 23670. The image hides a hyperlink to a Web page that shows a plan view of the layout of the property. The first user 20a then clicks at step 128 the plan view of the property and selects the kitchen. The Web browser 22a sends a message to the server 12 to request the correct image. The server 12 connects to the database 18 to retrieve the appropriate image, and sends back to the Web browser 22 a Web page which displays a picture of the kitchen. The first user 20a subsequently requests at steps 130, 132 and 134 to look at the dining room, followed by the bathroom and finally the garden. The Web pages that the user 20a has visited are logged at the server 12. The aforementioned steps are known in the prior art.

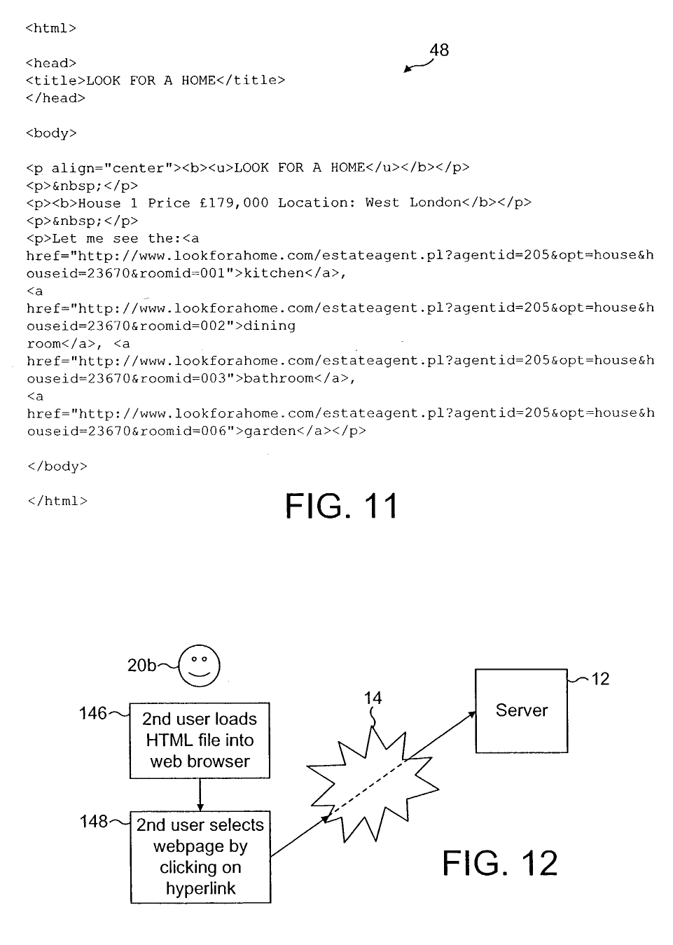

The first user 20a then requests at step 136 the session data 24 to be sent to him. As the server 12 has a record of each Web page that has been sent to the first user's Web browser 22, when the first user 20a requests the session data 24, the server 12 converts at step 138 this logged information 24 into an HTML file 48 and sends this file to the first user. The HTML file 48 is shown in FIG. 11, and contains a list of Web pages that the user 20a has visited in the order in which he has visited them.

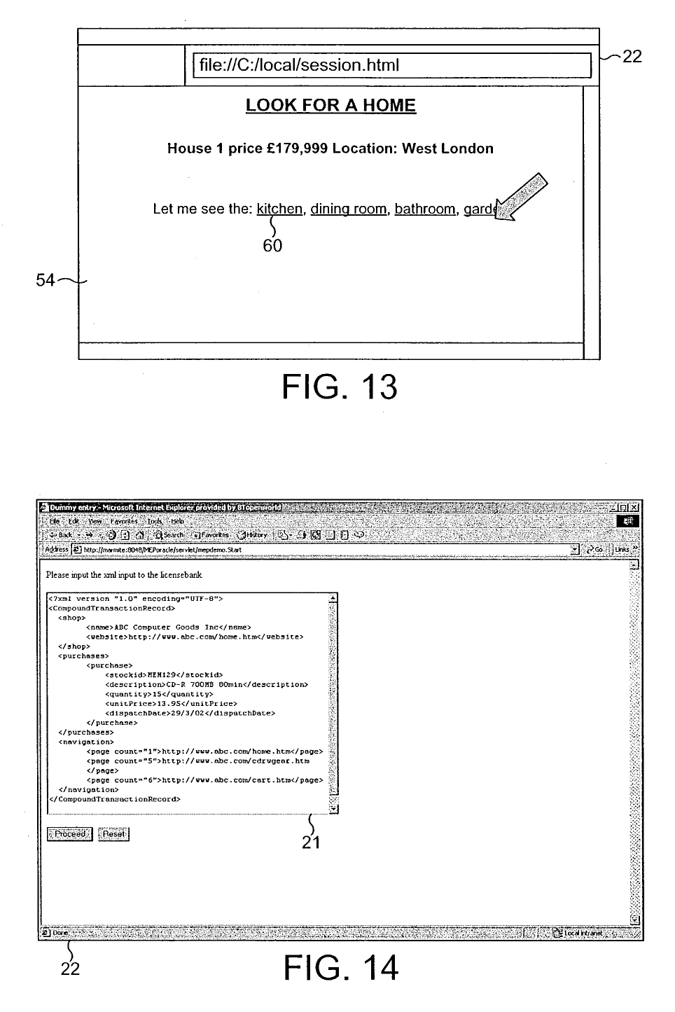

The first user 20a then sends the HTML file to a second user 20b. A procedure 140 used by the second user 20b to replay the tour from her Web browser 22b rather than the first user's Web browser 22a is now explained with reference to FIGS. 12 and 13 of the drawings.

Referring to FIG. 12, in order to replay the tour the second user 20b enters at step 146 the location of the HTML file 48 in her browser 22b and the Web page 54 shown in FIG. 13 is displayed. To look at the Web pages of the navigation that the first user 20a carried out on using his own Web browser 22a, the first user 20a simply clicks at step 148 on any of the hyperlinks 60 displayed in the Web page 54 to look at the Web navigation pages. By clicking on a hyperlink, the second user's Web browser 22b sends a GET request to the server 12 for that particular Web page, and the Web page is displayed in the Web browser. Using the present embodiment of the invention, the second user 20b can replay the navigation in any order, and/or replay the navigation any number of times.

It is also possible to send the transformed Web session document back to the server 12, and have the server transfer the navigation Web pages back to the user in the form of a slide show.

This embodiment of the invention is more suitable than the first embodiment if the Web session document only comprises a single page so that it can be sent to the first user 20a from the server using the HTTP protocol.

Having described two embodiments of the present invention, it is to be appreciated that the embodiments in question are exemplary only and that variations and modifications such as will occur to those possessed of the appropriate knowledge and skills may be made without departure from the spirit and scope of the invention as set forth in the appended claims. For example, the invention may also be used in interrupted purchases, i.e., a user can choose goods, interrupt the purchase (or be interrupted while making the purchase), and can resume the purchase where he left off rather than starting from the beginning. Also, collective purchases can be made where for example, several users in a department all want to purchase their books on line from a Web site, a first user can interact with the Web site selecting the required book, obtain their session data in the form of the portable format document and then pass the document onto the next user for them to repeat the selection steps and add their selection to the first user's selection and so on until the final user passes the collective Web session data to an administrator who can complete payment for all the selected books in a single transaction.

The method of the first embodiment of the invention may also be used to enable a group of individual Internet retailers to operate a virtual shopping centre or department store. For example, a group of retailers may get together so that a user can shop on-line without the need for re-entering personal and credit card details every time he wishes to make a purchase from a different Web site. Alternatively, in a large company, many people may want to join together to buy goods, possibly in bulk to lower costs, and have them all delivered at the same time to save on postage and packing. This is not possible using the cookie method of the prior art, as cookies are tightly bound to particular Web browsers, and to particular Web sites.

It is also possible to use cookies for a security measure in the case where it is required to prevent reuse of the Web session data document (or any part thereof) with the server unless the subsequent user's identity matches the identity of the original user whose interaction with a Web site is being replayed.

Means may also be provided for validation of the edited session data to ensure, for example, that a user does not order an incorrect and unreasonable amount of goods from an on-line department store. This data validation may be carried out either at the server-side or the client-side of the client-server environment.

It is also important to note that although the invention has been described in the context of human users, any of the steps of the preferred embodiments may be carried out by computer or other suitable device such as a mobile phone or a personal digital assistant.

1. A method of enabling reuse of Web session data generated at a server computer in a client/server environment during a Web session, the method comprising:
recording a client's interaction with a Web site thereby producing Web session data describing the Web session;
converting the Web session data into a document having a portable format; and
transferring the portable format document to a user such that it may be reused to regenerate at least a part of the Web session at a later point in time.

2. A method according to claim 1, wherein the recording step comprises storing the Web session data at the server generating the Web session data.

3. A method according to claim 1, wherein the recording step comprises storing the Web session data at one of a group comprising a further server computer and a database in communication with the server generating the Web session data.

4. A method according to claim 1, wherein the converting step comprises converting the Web session data from a server specific format into a standard, server independent, transmittable format.

5. A method according to claim 1, wherein the converting step comprises converting the Web session data from a server specific format into a user-definable mark-up language.

6. A method according to claim 5, wherein the converting step comprises converting the Web session data into an XML format.

7. A method according to claim 5, wherein the converting step comprises converting the Web session data into an HTML format.

8. A method according to claim 5, wherein the converting step comprises embedding the Web session data in a mark-up language form.

9. A method according to claim 1, wherein the converting step comprises parsing the Web session data at the server by use of a dedicated program stored on the server such as a Java Servlet.

10. A method according to claim 5, further comprising creating a set of interpretation instructions for converting the user-definable mark-up language into a displayable format.

11. A method according to claim 10, wherein the creating step comprises creating a set of interpretation instructions in XSL or XSLT.

12. A method according to claim 10, wherein the creating step comprises creating a set of Cascading Style Sheets.

13. A method according to claim 10, wherein the creating step comprises transforming the user-definable mark-up language into a standard mark-up language using the set of interpretation instructions and formatting the standard mark-up language into the desired configuration determined by the user-defined mark-up language.

14. A method according to claim 10, wherein the transferring step comprises sending to the user the set of interpretation instructions together with the Web session data converted into a user-definable mark-up language.

15. A method according to claim 1, wherein the transferring step comprises receiving a request for session data from the user and transferring the portable format document to the user in response thereto.

16. A method according to claim 15, wherein the request receiving step comprises selecting a send session option at the Web site.

17. A method according to claim 1, further comprising selecting at least a portion of the Web session data of the transferred portable format document for transmitting back to the server.

18. A method according to claim 17 further comprising transmitting at least the selected portion of the portable format document back to the server to regenerate the client's previous Web session.

19. A method according to claim 17 further comprising transmitting information derived from the portable format document back to the server to regenerate the client's previous Web session.

20. A method according to claim 18, wherein the transmitting step comprises transmitting at least the selected portion of the portable format document from a different Web browser to a Web browser which received the portable format document from the server.

21. A method according to claim 18, wherein the transmitting step comprises loading the portable format document into the Web browser as a form, viewing the data off-line, and thereafter connecting to the server and posting the form back thereto.

22. A method according to claim 18, wherein the transmitting step comprises connecting to the server and up-loading at least a portion of the portable format document back to the server.

23. A method according to claim 19, wherein the transmitting step comprises connecting to the server and up-loading information derived from the portable format document back to the server.

24. A method according to claim 22, further comprising sending a control program to the user, and wherein the transmitting step comprises using the control program to find the portable format document and to transmit the same to the server.

25. A method according to claim 24, wherein the step of using the control program comprises using an Applet or an ActiveX control.

26. A method according to claim 14, further comprising re-converting the user-definable mark-up language into a displayable format using the set of interpretation instructions.

27. A method according to claim 26, wherein the re-converting step comprises implementing the set of interpretation instructions and displaying the results of the conversion.

28. A method according to claim 26 or 27, wherein the re-converting step comprises transforming the user-definable mark-up language into a standard mark-up language and formatting the standard mark-up language into the desired configuration determined by the user-defined mark-up language.

29. A method according to claim 1, further comprising displaying the Web session data of the transferred portable format document in a Web browser of the user.

30. A method according to claim 1, further comprising editing the Web session data of the transferred portable format document.

31. A method according to claim 1, wherein the recording step comprises recording data entry/data selection by the user during the Web session with the Web site.

32. A method according to claim 1, wherein the recording step comprises recording user navigation during the Web session with at least one Web site such that the Web session data represents the user's navigation history through the at least one Web site.

33. A method according to claim 32, further comprising displaying the user navigation as a series of hyperlinks, each hyperlink enabling an on-line connection to a Web site to be made.

34. A method according to claim 33, further comprising selecting the hyperlinks in a different order to that originally visited by the user.

35. A method according to claim 32, further comprising sending the portable format document of the user's navigation history to the server, and replaying the history of the user's navigation as a series of representations, each representation being displayed for a set period of time before the next one in the series is displayed.

36. A method according to claim 32, further comprising sending a cookie from the server to the user, the cookie noting the user's identity, and preventing reuse of the portable format document or any part thereof with the server unless the user's identity matches the identity of the original user whose interaction is being replayed.

37. A method according to claim 1, wherein the Web session data represents a history of the user's interaction with a plurality of different Web pages and the recording step comprises recording the interaction with each of the Web pages.

38. A method according to claim 37, wherein the recording step comprises recording shopping cart data representing the Web sites visited, goods/services selected for purchase and the prices of the selected goods/services.

39. A method according to claim 38, further comprising transmitting at least a portion of the portable format document back to the server to regenerate the multiple Web site shopping interaction session and making a single payment to the server for all the selected goods/services to finalise the purchase.

40. A method according to claim 38, further comprising transmitting information derived from the portable format document back to the server to regenerate the multiple Web site shopping interaction session and making a single payment to the server for all the selected goods/services to finalise the purchase.

41. A system for enabling reuse of Web session data generated at a server computer in a client/server environment during a Web session, the system comprising:
communication means for supporting communications between a user and a Web site;
capture means arranged to capture session data arising from the user's interaction with the Web site;
conversion means arranged to convert the Web session data into a document having a portable format; and
transfer means for transferring the portable format document to the user from the server computer via the communications means.

42. A system according to claim 41, wherein the communications means comprises a wide area communications network and the system further comprises a client computer arranged to communicate over the communications network.

43. A system according to claim 42, wherein the client computer comprises a Web browser, and the transfer means comprises a server computer arranged to provide Web pages of the Web site to the Web browser.

44. A system according to claim 41, wherein the client computer comprises means for enabling the user to view and edit the portable format document.

45. A system according to claim 41, wherein the client computer comprises means for reconnecting to the server and transmitting at least a part of the portable format document back to the server to continue the user's interaction with the Web site represented by the portable format document.

46. A system according to claim 44, wherein Web session data comprises a navigation history of the user's previous Web session and the viewing means is arranged to display the navigation history as a series of hyperlinks which are selectable to connect the user to the Web site specified by the hyperlink.

47. A system according to claim 41, further comprising a plurality of server computers each configured to receive at least a part of the portable format document and to regenerate a corresponding part of the Web session.

48. A data carrier comprising a computer program arranged to configure a client/server system to implement the method according to claim 1.

49. A system for enabling reuse of Web session data generated at a server computer in a client/server environment during a Web session, the system comprising:
a communications network for supporting communications between a user and a Web site;
a servlet arranged to: capture Web session data arising from the user's interaction with the Web site; convert the Web session data into a document having a portable format; and transfer the portable format document to the user from the server computer via the communications network.

50. A system according to claim 49, further comprising a client computer arranged to
communicate over the communications network, wherein the client computer comprises a communications engine for reconnecting to the server and transmitting at least part of the portable format document back to the server to continue the user's interaction with the Web site represented by the portable format document.

51. A system according to claim 49, further comprising a client computer arranged to communicate over the communications network and a Web browser provided on a client computer, wherein the Web session data comprises a navigation history of the user's previous Web session and the Web browser is arranged to display the navigation history as a series of hyperlinks which are selectable to connect the user to the Web site specified by the hyperlink.

52. A method of enabling reuse of Web session data generated at a server computer in a client/server environment during a Web session, the method comprising:
recording a client's interaction with at least one Web site thereby producing Web session data, wherein the Web session data comprises shopping cart data representing the Web site(s) visited, goods/services selected for purchase and the prices of the selected goods/services;
converting the Web session data into an XML document;
transferring the XML document to a user such that it may be reused to regenerate at least a part of the Web session at a later point in time;
transmitting at least a portion of the XML document back to the server to regenerate at least part of the Web session; and
making a single payment to the server for all the selected goods and services to finalise the purchase.

53. A method of enabling reuse of Web session data generated at a server computer in a client/server environment, the method comprising:
recording a client's interaction with at least one Web site thereby producing Web session data, wherein the Web session data comprises shopping cart data representing the Web site(s) visited, goods/services selected for purchase and the prices of the selected goods or services;
converting the Web session data into an XML document;
transferring the XML document to a user such that it may be reused to regenerate at least a part of the Web session at a later point in time;
converting the XML document into an HTML document;
loading the HTML document into a Web browser as an editable form;
transmitting the editable form or at least a portion thereof back to the server to regenerate the client's interaction with the at least one Web site; and
making a single payment to the server for all the selected goods/services to finalise the purchase.

54. A method of enabling reuse of Web session data generated at a server computer in a client/server environment during a Web session, the method comprising:
recording a client's interaction with a Web site thereby producing Web session data;
converting the Web session data from a server specific format into a mark-up language document;
transferring the mark-up language document to a user such that it may be reused to regenerate at least one part of the Web session at a later point in time; and
displaying the Web session data of the transferred mark-up language document in a Web browser of the user to regenerate the at least one part of the Web session.

55. A method of enabling reuse of Web session data generated at a server computer in a client/server environment, the method comprising:
recording a user's navigation with a Web site comprising at least one Web page thereby producing Web session data representing the user's navigation history through the Web site;
converting the Web session data into an HTML document, the HTML document including at least one hyperlink corresponding to the Web page(s) visited by the user;
transferring the HTML document to the user such that it may be reused to regenerate at least a part of the user's navigation history at a later point in time; and
displaying the user's navigation as a series of hyperlinks, each hyperlink enabling an on-line connection to a Web page of the Web site to be made.

56. A method of enabling reuse of Web session data generated at a server computer in a client/server environment, the method comprising:
recording a user's navigation with a Web site comprising at least one Web page thereby producing Web session data representing the user's navigation history through the Web site;
converting the Web session data into an HTML document, the HTML document including at least one hyperlink corresponding to the Web page(s) visited by the user;
transferring the HTML document to the user such that it may be reused to generate at least part of the user's navigation history at a later point in time;
sending the HTML document to the server; and
replaying the user's navigation history as a series of Web pages wherein each Web page is displayed in a Web browser for a set period of time before the next one in the series is displayed.
